(19) United States
(12) Patent Application Publication
(10) Pub. No.: US 2026/0160391 A1
(43) Pub. Date: Jun. 11, 2026

(54) HYDROGEN SUPPLY SYSTEM

(71) Applicants: HYUNDAI MOTOR COMPANY, Seoul (KR); KIA CORPORATION, Seoul (KR)

(72) Inventors: Yeon Ho Kim, Hwaseong-si (KR); Hochan An, Hwaseong-si (KR); Narae Yoon, Hwaseong-si (KR); Pyung Soon Kim, Hwaseong-si (KR); Ji-Hoon Jang, Hwaseong-si (KR); Jihye Park, Hwaseong-si (KR); Gwi Taek Kim, Hwaseong-si (KR); Hoyoung Jeong, Hwaseong-si (KR); Hanjin Kim, Hwaseong-si (KR); Man Hee Park, Hwaseong-si (KR); Yeong Jun Kim, Hwaseong-si (KR); Jae Yeon Kim, Hwaseong-si (KR); Jeawan Kim, Hwaseong-si (KR)

(73) Assignees: HYUNDAI MOTOR COMPANY, Seoul (KR); KIA CORPORATION, Seoul (KR)

(21) Appl. No.: 19/230,475

(22) Filed: Jun. 6, 2025

(30) Foreign Application Priority Data
Dec. 9, 2024 (KR) 10-2024-0181539

(51) Int. Cl. F17C 11/00; F17C 7/00

(52) U.S. Cl. CPC F17C 11/005; F17C 7/00; F17C 2205/0323; F17C 2205/0352; F17C 2221/012; F17C 2227/0355; F17C 2265/065

(57) ABSTRACT

A hydrogen supply system includes a first refrigerant circuit including a first refrigerant line along which refrigerant circulates, and a first heat-exchanger, a first compressor, a second heat-exchanger, and a first expansion valve sequentially disposed on the first refrigerant line. The system further includes a second refrigerant circuit including a second refrigerant line along which the refrigerant circulates, and the second heat-exchanger, a second compressor, a third heat-exchanger, and a second expansion valve sequentially disposed on the second refrigerant line. The system further includes a coolant circuit including a coolant line along which the coolant is selectively heat-exchanged with the refrigerant circulating the first refrigerant circuit and the refrigerant circulating the second refrigerant circuit circulates, and a hydrogen compression tank disposed on the coolant line and configured to store a metal hydride. The hydrogen gas is stored and compressed through a metal stored in the hydrogen compression tank.

### CROSS-REFERENCE TO RELATED APPLICATION

This application claims priority to and the benefit of Korean Patent Application No. 10-2024-0181539 filed with the Korean Intellectual Property Office on Dec. 9, 2024, the entire contents of which are incorporated herein by reference.

### TECHNICAL FIELD

The present disclosure relates to a hydrogen supply system, and more particularly, the present disclosure relates to a hydrogen supply system capable of storing and compressing hydrogen gas by using metal hydride.

### BACKGROUND

Recently, with a continuously increased interest in energy efficiency and an environmental pollution problem, the development of an environmentally-friendly vehicle capable of substantially substituting for an internal combustion engine vehicle is required.

The environment-friendly vehicle is classified into an electric vehicle driven using a fuel cell or electricity as a power source and a hybrid vehicle driven using an engine and an electrical battery.

A hydrogen vehicle is equipped with a cartridge storing hydrogen gas and generates power required for driving the vehicle by combusting the hydrogen stored in the cartridge.

When the hydrogen gas is consumed while the hydrogen vehicle is driving, hydrogen gas must be refilled into the cartridge at a hydrogen charging station. Conventionally, electric compressors are used to charge hydrogen gas into the cartridge at hydrogen charging stations.

However, when charging hydrogen gas into the cartridge by using an electric compressor, there is a problem that a lot of electric energy is consumed and maintenance costs are increased.

The matters described in the description of the related art are intended to enhance the understanding of the background of the present disclosure and may include matters that are not already known to those having ordinary skill in the art to which the present technology belongs.

### SUMMARY

The present disclosure attempts to provide a hydrogen supply system capable of decreasing electrical energy consumption and decreasing the maintenance cost.

A hydrogen supply system may include a first refrigerant circuit including a first refrigerant line along which refrigerant circulates. The first refrigerant circuit further includes a first heat-exchanger, a first compressor, a second heat-exchanger, and a first expansion valve sequentially disposed on the first refrigerant line. The hydrogen supply system may further include a second refrigerant circuit including a second refrigerant line along which the refrigerant circulates. The second refrigerant circuit further includes the second heat-exchanger, a second compressor, a third heat-exchanger, and a second expansion valve sequentially disposed on the second refrigerant line. The hydrogen supply system may further include a coolant circuit including a coolant line along which the coolant is selectively heat-exchanged with the refrigerant circulating the first refrigerant circuit and the refrigerant circulating the second refrigerant circuit circulates. The coolant circuit further includes a hydrogen compression tank disposed on the coolant line and configured to store a metal hydride,. The hydrogen gas is stored and compressed through a metal stored in the hydrogen compression tank depending on a temperature change of the coolant circulating the coolant line.

The coolant circuit may include a first coolant circuit including a first coolant line along which the coolant is heat-exchanged with the refrigerant circulating the first refrigerant circuit circulates. The first coolant circuit further includes a connection line selectively connected to the first coolant line and on which the hydrogen compression tank is disposed. The coolant circuit may further include a second coolant circuit including a second coolant line along which the coolant is heat-exchanged with the refrigerant circulating the second refrigerant circuit circulates. The second coolant circuit further includes the connection line selectively connected to the second coolant line and on which the hydrogen compression tank is disposed. The second coolant circuit further includes a cooling valve installed on the connection line, and configured to selectively supply the coolant circulating the first coolant line and the coolant circulating the second coolant line to hydrogen compression tank.

The cooling valve may be a 4-way valve.

The first coolant line may include an eleventh coolant line on which a first coolant pump and the first heat-exchanger are disposed. The first coolant line may further include a first connection line selectively and fluidically connected to the eleventh coolant line and on which the hydrogen compression tank is disposed. The first coolant line may further include a second connection line selectively and fluidically connected to the eleventh coolant line and on which a radiator is disposed. The first coolant line may further include a twelfth coolant line selectively and fluidically connected to the first connection line. The first coolant line may further include a thirteenth coolant line selectively and fluidically connected to the second connection line.

The second coolant line may include a twenty-first coolant line on which a second coolant pump and the third heat-exchanger are disposed. The second coolant line may further include the first connection line selectively and fluidically connected to the twenty-first coolant line and on which the hydrogen compression tank is disposed. The second coolant line may further include the second connection line selectively and fluidically connected to the twenty-first coolant line and on which the radiator is disposed. The second coolant line may further include a twenty-second coolant line selectively and fluidically connected to the first connection line. The second coolant line may further include a twenty-third coolant line selectively and fluidically connected to the second connection line.

The cooling valve may be installed at a location where the first connection line, the second connection line, the eleventh coolant line, and the twenty-first coolant line join.

The hydrogen compression tank may include a tank body configured to accommodate the metal hydride. The hydrogen compression tank may further include a coolant inlet line selectively and fluidically connected to the second connection line. The hydrogen compression tank may further include a coolant discharge line selectively and fluidically connected to the first connection line. The hydrogen compression tank may further include a hydrogen inlet line configured to supply the hydrogen gas to the tank body and on which a first hydrogen valve is disposed. The hydrogen compression tank may further include a hydrogen discharge line configured to discharge the hydrogen gas desorbed from the metal hydride and on which a second hydrogen valve is disposed.

Depending on operations of the cooling valve, a first hydrogen valve, and a second hydrogen valve, the hydrogen supply system is configured to operate in one mode among a cooling mode for cooling the metal of the hydrogen compression tank; an adsorption mode for adsorbing the hydrogen gas on the metal in the hydrogen compression tank; a heating mode for heating the metal hydride in the hydrogen compression tank; and a discharge mode for discharging the hydrogen gas compressed at the hydrogen compression tank.

In the cooling mode, the cooling valve fluidically may connect the eleventh coolant line and the first connection line and fluidically may connect the twenty-first coolant line and the second connection line, and the first hydrogen valve and the second hydrogen valve may be blocked.

In the adsorption mode, the cooling valve fluidically may connect the eleventh coolant line and the first connection line and fluidically may connect the twenty-first coolant line and the second connection line, the first hydrogen valve may be opened, and the second hydrogen valve may be blocked.

In the heating mode, the cooling valve fluidically may connect the eleventh coolant line and the second connection line and fluidically may connect the twenty-first coolant line and the first connection line, and the first hydrogen valve and the second hydrogen valve may be blocked.

In the discharge mode, the cooling valve fluidically may connect the eleventh coolant line and the second connection line and fluidically may connect the twenty-first coolant line and the first connection line, the first hydrogen valve may be blocked, and the second hydrogen valve may be opened.

According to an embodiment, by storing and compressing the hydrogen gas depending on the temperature change of the metal hydride, the electrical energy consumption may be decreased and the maintenance cost may be reduced.

Other effects that may be obtained or are predicted by an embodiment are explicitly or implicitly described in a detailed description of the present disclosure. In other words, various effects that are predicted according to embodiments are described in the following detailed description.

### BRIEF DESCRIPTION OF THE DRAWINGS

These drawings are for reference in describing embodiments of the present disclosure, and the technical spirit of the present disclosure should not be construed as being limited to the accompanying drawings.

FIG. 1 is a schematic view showing a configuration of a hydrogen charging station to which a hydrogen supply system according to an embodiment is applied.

FIG. 2 is a block diagram showing a configuration of a hydrogen supply system according to an embodiment.

FIG. 3 is a schematic view showing a configuration of a hydrogen compression tank according to an embodiment.

FIG. 4, FIG. 5, and FIG. 6 are drawings for explaining a cooling mode and an adsorption mode of a hydrogen supply system according to an embodiment.

FIG. 7, FIG. 8, and FIG. 9 are drawings for explaining a heating mode and a discharge mode of a hydrogen supply system according to an embodiment.

It should be understood that the above-referenced drawings are not necessarily to scale but present a somewhat simplified representation of various features illustrating the basic principles of the disclosure. The specific design features of the present disclosure, including, for example, specific dimensions, orientations, locations, and shapes, should be determined in part by the particular intended application and use environment.

### DETAILED DESCRIPTION

The terms used herein are for the purpose of describing particular embodiments only and are not intended to limit the present disclosure. As used herein, the singular forms are intended to include the plural forms as well, unless the context clearly indicates otherwise. It should be further understood that the terms, such as “comprises” and “comprising,” when used in the present disclosure, specify the presence of stated features, integers, steps, operations, elements, and/or components and do not preclude the presence or addition of one or more other features, integers, steps, operations, elements, components, and/or groups thereof. As used herein, the term “and/or” includes any one or all combinations of one or more related items.

The present disclosure is described more fully hereinafter with reference to the accompanying drawings, in which embodiments of the disclosure are illustrated. As those having ordinary skill in the art should realize, the described embodiments may be modified in various different ways, without departing from the spirit or scope of the present disclosure.

The drawings and description should be regarded as illustrative in nature and not restrictive, and like reference numerals designate like elements throughout the present disclosure.

In addition, the size and thickness of each configuration shown in the drawings are arbitrarily shown for understanding and ease of description, but the present disclosure is not limited thereto, and the thickness of layers, films, panels, regions, etc., are exaggerated for clarity.

The terms, such as “module” and “unit” for a constituent element, used for the present disclosure are given in consideration of only easiness of the writing of the present disclosure, and the terms themselves do not have a discriminated meaning or role. When a controller, module, unit, component, device, element, or the like of the present disclosure is described as having a purpose or performing an operation, function, or the like, the controller, module, unit, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Further, in describing the embodiments disclosed in the present disclosure, when it is determined that detailed description relating to well-known functions or configurations may make the subject matter of the embodiments disclosed in the present disclosure unnecessarily ambiguous, the detailed description has been omitted.

Further, the accompanying drawings are provided for helping to easily understand embodiments disclosed in the present disclosure, and the technical spirit disclosed in the present disclosure is not limited by the accompanying drawings. It should be appreciated that the present disclosure includes all of the modifications, equivalent matters, and substitutes included in the spirit and the technical scope of the present disclosure.

Terms including ordinal numbers, such as first, second, and the like, are used only to describe various components and should not be interpreted as limiting these components.

As used herein, the singular forms, such as “a”, “an” and “the,” are intended to include the plural forms as well, unless the context clearly indicates otherwise.

The terms are only used to differentiate one component from others.

A hydrogen charging station to which a hydrogen supply system according to an embodiment is applied is described in detail.

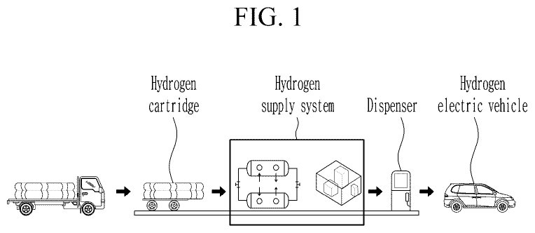

FIG. 1 is a schematic view showing a configuration of a hydrogen charging station to which a hydrogen supply system according to an embodiment is applied.

First, referring to FIG. 1, a hydrogen charging station to which a hydrogen supply system according to an embodiment is applied is described in detail.

A hydrogen supply system according to an embodiment may be applied to a hydrogen charging station configured to charge the hydrogen gas.

A hydrogen supply system according to an embodiment may store or compress the hydrogen gas by utilizing the principle that hydrogen is adsorbed on or desorbed from the metal hydride (MH) depending on the temperature change of the metal hydride (MH).

For example, when a metal is cooled, hydrogen molecules may be adsorbed onto metal molecules, and the hydrogen gas may be stored in a container containing the metal hydride. To the contrary, when the metal hydride is heated, hydrogen molecules adsorbed on the metal hydride may be desorbed, and the hydrogen gas may be compressed in a container containing the metal hydride.

By utilizing such a principle, a hydrogen supply system according to an embodiment may be applied to a hydrogen charging station. For example, when a hydrogen cartridge is loaded onto a tube trailer and enters a hydrogen charging station, the hydrogen charged inside hydrogen cartridge may be supplied to the hydrogen supply system and may cool the metal inside the hydrogen supply system so that the hydrogen may be stored in the form of metal hydride. Thereafter, when the metal hydride is heated so that hydrogen is desorbed from the metal hydride and the pressure increases, the hydrogen gas may be charged into the hydrogen electric vehicle, via a dispenser.

Hereinafter, a hydrogen supply system according to an embodiment is described in detail with reference to the drawings.

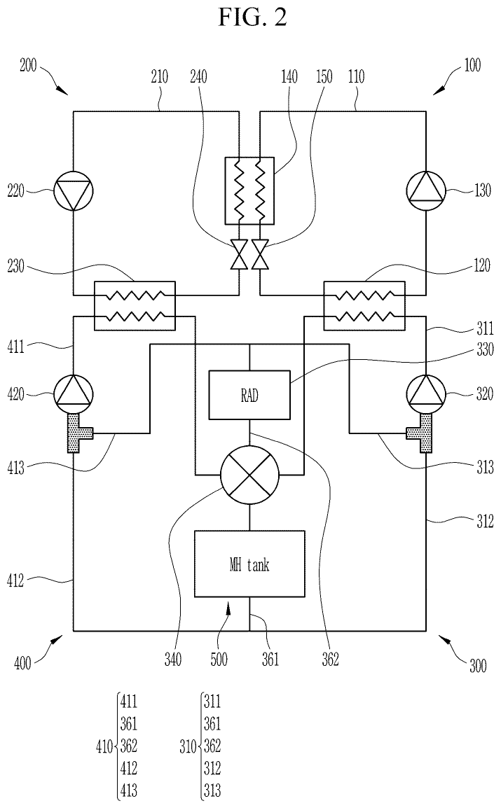

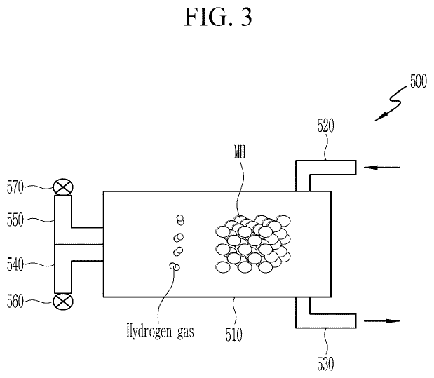

FIG. 2 is a block diagram showing a configuration of a hydrogen supply system according to an embodiment. In addition, FIG. 3 is a schematic view showing a configuration of a hydrogen compression tank according to an embodiment.

As shown in FIG. 2, a hydrogen supply system according to an embodiment may include a first refrigerant circuit 100 in which the refrigerant circulates, a second refrigerant circuit 200 in which the refrigerant circulates, and the coolant selectively heat-exchanged with the refrigerant circulating the first refrigerant circuit 100 and a coolant circuit in which the refrigerant circulating the second refrigerant circuit 200 circulates.

The first refrigerant circuit 100 may include a first refrigerant line 110 along which the refrigerant circulates and may include and include a first heat-exchanger 120, a first compressor 130, a second heat-exchanger 140, and a first expansion valve 150 sequentially disposed on the first refrigerant line 110. The first heat-exchanger 120, the first compressor 130, the second heat-exchanger 140, and the first expansion valve 150 may be sequentially disposed on the first refrigerant line 110 along the flow direction of the refrigerant.

The second refrigerant circuit 200 may include a second refrigerant line 210 along which the refrigerant circulates and may include a third heat-exchanger 230, a second expansion valve 240, the second heat-exchanger 140, and a second compressor 220 sequentially disposed on the second refrigerant line 210. The third heat-exchanger 230, the second expansion valve 240, the second heat-exchanger 140, and the second compressor 220 may be sequentially disposed on the second refrigerant line 210 along the flow direction of the refrigerant.

The coolant circuit may include a coolant line along which the coolant selectively heat-exchanging with the refrigerant circulating the first refrigerant circuit 100 and the refrigerant circulating the second refrigerant circuit 200 circulates. The coolant circuit may further include a hydrogen compression tank 500 disposed on the coolant line.

For such a purpose, the coolant circuit may include a first coolant circuit 300 in which the coolant heat-exchanged with the refrigerant circulating the first refrigerant circuit 100 circulates. The coolant circuit may further include a second coolant line 410 in which the coolant heat-exchanged with the refrigerant circulating the second refrigerant circuit 200 circulates.

The first coolant circuit 300 may include a first coolant line 310 along which the coolant circulates, a first coolant pump 320 disposed on the first coolant line 310, a radiator 330 disposed on the first coolant line 310, and the hydrogen compression tank 500 disposed on the first coolant line 310.

In more detail, the first coolant line 310 may include an eleventh coolant line 311 on which the first coolant pump 320 and the first heat-exchanger 120 are disposed. The first coolant line 310 may further include a first connection line 361 selectively and fluidically connected to the eleventh coolant line 311 and on which the hydrogen compression tank 500 is disposed. The first coolant line 310 may further include a second connection line 362 selectively and fluidically connected to the eleventh coolant line 311 and on which the radiator 330 is disposed. The first coolant line 310 may further include a twelfth coolant line 312 selectively and fluidically connected to the first connection line 361. The first coolant line 310 may further include a thirteenth coolant line 313 selectively and fluidically connected to the second connection line 362.

The first coolant pump 320 can pump the coolant circulating the first coolant circuit 300.

The radiator 330 may cool the coolant circulating the first coolant circuit 300 by heat-exchanging it with the external air.

A second coolant circuit 400 may include the second coolant line 410 along which the coolant circulates, a second coolant pump 420 disposed on the second coolant line 410, the radiator 330 disposed on the second coolant line 410, and the hydrogen compression tank 500 disposed on the second coolant line 410.

In more detail, the second coolant line 410 may include a twenty-first coolant line 411 on which the second coolant pump 420 and the third heat-exchanger 230 are disposed. The second coolant line 410 may further include the first connection line 361 selectively and fluidically connected to the twenty-first coolant line 411 and on which the hydrogen compression tank 500 is disposed. The second coolant line 410 may further include the second connection line 362 selectively and fluidically connected to the twenty-first coolant line 411 and on which the radiator 330 is disposed. The second coolant line 410 may further include a twenty-second coolant line 412 selectively and fluidically connected to the first connection line 361. The second coolant line 410 may further include a twenty-third coolant line 413 selectively and fluidically connected to the second connection line 362.

The second coolant pump 420 can pump the coolant circulating the second coolant circuit 400.

The radiator 330 may cool the coolant circulating the second coolant circuit 400 by heat-exchanging it with the external air.

A cooling valve 340 may be installed at a location where the first connection line 361, the second connection line 362, the eleventh coolant line 311, and the twenty-first coolant line 411 join. The cooling valve 340 may be implemented as a 4-way valve.

Depending on an operation of the cooling valve 340, it is possible that the eleventh coolant line 311 and the first connection line 361 are fluidically connected and the twenty-first coolant line 411 and the second connection line 362 are fluidically connected. Alternatively, it is possible that the eleventh coolant line 311 and the second connection line 362 are fluidically connected and the twenty-first coolant line 411 and the first connection line 361 are fluidically connected.

Depending on the operation of the cooling valve 340, the eleventh coolant line 311 and the first connection line 361 may be fluidically connected, and the twenty-first coolant line 411 and the second connection line 362 may be fluidically connected, so that the eleventh coolant line 311, the first connection line 361, and the twelfth coolant line 312 may form a closed circuit, and the twenty-first coolant line 411, the second connection line 362, and the twenty-third coolant line 413 may form a closed circuit.

Depending on the operation of the cooling valve 340, the eleventh coolant line 311 and the second connection line 362 may be fluidically connected, and the twenty-first coolant line 411 and the first connection line 361 may be fluidically connected, so that the eleventh coolant line 311, the second connection line 362, and the thirteenth coolant line 313 may form a closed circuit, and the twenty-first coolant line 411, the first connection line 361, and the twenty-second coolant line 412 may form a closed circuit.

The cooling valve 340 may selectively supply the coolant circulating the first coolant line 310 and the coolant circulating the second coolant line 410 to the hydrogen compression tank 500. In other words, depending on the operation of the cooling valve 340, the coolant circulating the first coolant line 310 may be supplied to the hydrogen compression tank 500, or the coolant circulating the second coolant line 410 may be supplied to the hydrogen compression tank 500.

The metal hydride (MH) may be stored inside the hydrogen compression tank 500. The metal hydride stored in the hydrogen compression tank 500 may store and compress the hydrogen gas depending on the temperature change of the coolant circulating the coolant line.

As described above, when a metal is cooled by a cold coolant, hydrogen molecules may be adsorbed on the metal, and accordingly, the hydrogen gas may be stored in the hydrogen compression tank 500. To the contrary, when the metal hydride is heated by the high-temperature coolant, hydrogen molecules adsorbed on the metal may be desorbed, and accordingly, the hydrogen gas may be compressed in the hydrogen compression tank 500.

Referring to FIG. 3, the hydrogen compression tank 500 may include a tank body 510 storing metal hydride, a coolant inlet line 520 for introducing the coolant into the tank body 510, a coolant discharge line 530 for discharging the coolant received through the coolant inlet line 520 and having circulated in the tank body 510, a hydrogen inlet line 540 for supplying the hydrogen gas to the tank body 510, and a hydrogen discharge line 550 for discharging the hydrogen gas generated at the tank body 510.

The coolant inlet line 520 may be selectively and fluidically connected to a connection line on an upstream side of the hydrogen compression tank 500, and the coolant discharge line 530 may be fluidically connected to a connection line on a downstream side of the hydrogen compression tank 500.

A first hydrogen valve 560 may be disposed on the hydrogen inlet line 540. Depending on the opening and closing of the first hydrogen valve 560, the hydrogen gas may be selectively supplied to the tank body 510. When the first hydrogen valve 560 is opened, the hydrogen gas may be introduced into the tank body 510, and when the first hydrogen valve 560 is blocked, the hydrogen gas is not introduced into the tank body 510.

A second hydrogen valve 570 may be disposed on the hydrogen discharge line 550. Depending on the opening and closing of the second hydrogen valve 570, the hydrogen gas generated at the tank body 510 may be selectively discharged. When the second hydrogen valve 570 is opened, the hydrogen gas generated inside the tank body 510 may be discharged to the outside of the tank body 510, and when the second hydrogen valve 570 is blocked, the hydrogen gas generated inside the tank body 510 is not discharged to the outside of the tank body 510.

As described above, the metal hydride (MH) may be accommodated inside the tank body.

Depending on the operation of the cooling valve 340, the tank body 510 may be cooled by the cold coolant, and when the hydrogen gas is supplied to the tank body 510 through the hydrogen inlet line 540, hydrogen molecules may be adsorbed on the metal. Accordingly, the hydrogen gas may be stored inside the tank body 510.

To the contrary, depending on the operation of the cooling valve, when the tank body 510 is heated by the high-temperature coolant, hydrogen molecules may be desorbed from the metal hydride, and the hydrogen gas may be compressed inside the tank body 510.

Referring back to FIG. 2, the first compressor 130 disposed in the first refrigerant circuit 100 may compress a gaseous refrigerant into a high-temperature and high-pressure gaseous refrigerant.

The first heat-exchanger 120 may heat-exchange the refrigerant circulating the first refrigerant line 110 and the refrigerant circulating the second refrigerant line 210, and the refrigerant compressed by the first compressor 130 may be condensed into a liquid state. In other words, the first heat-exchanger 120 may condense the refrigerant supplied from the first compressor 130 through heat-exchange with the refrigerant supplied through the second refrigerant line 210. In this case, in the first refrigerant circuit 100, the first heat-exchanger 120 may perform the function of a condenser.

The first expansion valve 150 may expand the refrigerant condensed by the first heat-exchanger 120, and the pressure of the refrigerant is decreased from a high pressure to a low pressure.

The second heat-exchanger 140 may heat-exchange the refrigerant circulating the first refrigerant line 110 and the coolant circulating the first coolant line 310 and may vaporize the low-pressure refrigerant having passed through the first expansion valve 150. Accordingly, the refrigerant in the liquid state may be phase-changed to a gaseous refrigerant. In addition, as the coolant circulating the first refrigerant circuit 100 is heat-exchanged with the cold refrigerant at the second heat-exchanger 140, the temperature of the coolant is lowered. In this case, in the first refrigerant circuit 100, the second heat-exchanger 140 may perform the function of an evaporator.

In an embodiment, the first refrigerant circuit 100 may perform the function of a cooling apparatus for cooling the refrigerant flowing through the first coolant line 310.

The second compressor 220 disposed in the second refrigerant circuit 200 may compress a gaseous refrigerant into a high-temperature and high-pressure gaseous refrigerant.

The third heat-exchanger 230 may perform a heat-exchange between the coolant circulating the second coolant line 410 and the refrigerant circulating the first refrigerant line 110, and the refrigerant compressed by the second compressor 220 may be condensed into a liquid state in the third heat-exchanger 230. In addition, as the coolant circulating the second coolant line 410 is heat-exchanged with the high-temperature refrigerant at the third heat-exchanger 230, the temperature of the coolant is increased. In this case, in the second refrigerant circuit 200, the third heat-exchanger 230 may perform the function of a condenser.

The second expansion valve 240 may expand the refrigerant condensed by the third heat-exchanger 230, and the pressure of the refrigerant is decreased from a high pressure to a low pressure.

The first heat-exchanger 120 may heat-exchange the refrigerant circulating the second refrigerant line 210 and the refrigerant circulating the first refrigerant line 110 and may vaporize the low-pressure refrigerant having passed through the second expansion valve 240. In this case, in the second refrigerant circuit 200, the first heat-exchanger 120 may perform the function of an evaporator.

In an embodiment, the second refrigerant circuit 200 may perform the function of a heating device for heating the refrigerant flowing through the second coolant line 410.

Hereinafter, operation of a hydrogen supply system according to an embodiment is described in detail with reference to the drawings.

A hydrogen supply system according to an embodiment may operate in one mode among a cooling mode for cooling the metal hydride of the hydrogen compression tank 500, an adsorption mode for adsorbing the hydrogen gas on the metal hydride in the hydrogen compression tank 500, a heating mode (or, compression mode) for heating the metal hydride in the hydrogen compression tank 500, and a discharge mode for discharging the hydrogen gas compressed at the hydrogen compression tank 500, depending on the operation of the cooling valve 340, the first hydrogen valve 560, and the second hydrogen valve 570.

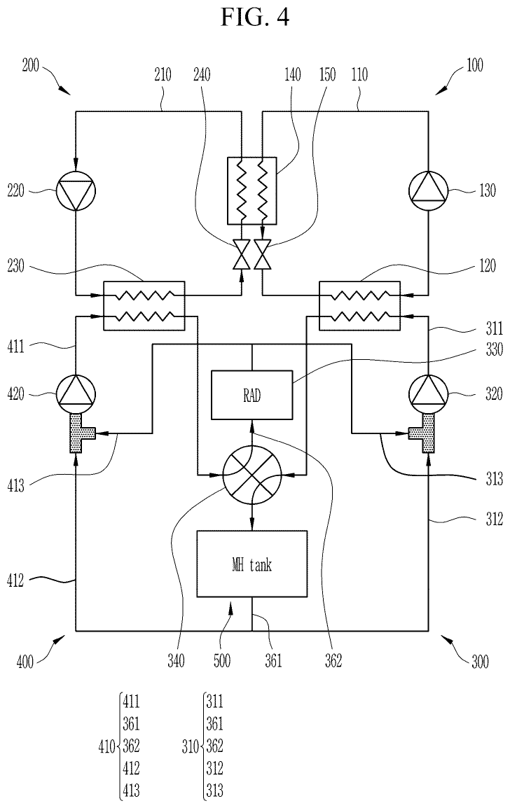

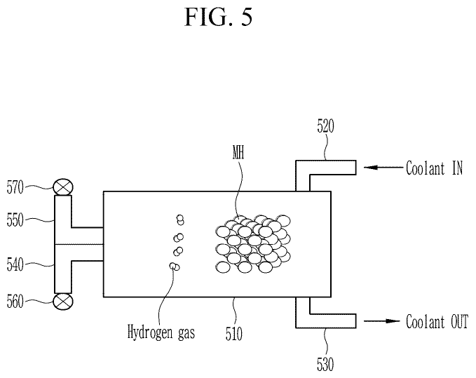

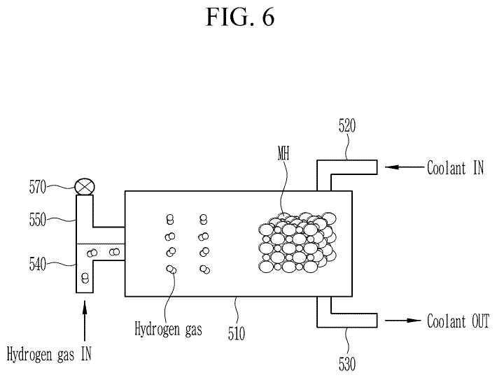

The cooling mode is described in detail with reference to FIG. 4 and FIG. 5. The cooling mode may be a mode for cooling the metal stored inside the hydrogen compression tank 500.

Referring to FIG. 4 and FIG. 5, in the cooling mode, the cooling valve 340 may be fluidically connect the eleventh coolant line 311 and the first connection line 361 and may fluidically connect the twenty-first coolant line 411 and the second connection line 362. In addition, the first hydrogen valve 560 and the second hydrogen valve 570 may be blocked.

Depending on the operation of the cooling valve 340, the eleventh coolant line 311, the first connection line 361, and the twelfth coolant line 312 may form a closed circuit, and the twenty-first coolant line 411, the second connection line 362, and the twenty-third coolant line 413 may form a closed circuit.

As the eleventh coolant line 311, the first connection line 361, and the twelfth coolant line 312 form a closed circuit, the cold refrigerant circulating the first refrigerant circuit 100 and the coolant circulating the first coolant circuit 300 may be heat-exchanged in the second heat-exchanger 140, so that the temperature of the coolant circulating the first coolant circuit 300 is lowered.

The cooled coolant may cool the hydrogen compression tank 500 through the first connection line 361 and the coolant inlet line 520, and the metal stored inside the tank body 510 may be cooled.

As the first hydrogen valve 560 and the second hydrogen valve 570 are blocked, the hydrogen gas is not introduced into the hydrogen compression tank 500.

In addition, the high-temperature refrigerant circulating the second refrigerant circuit 200 and the coolant circulating the second coolant circuit 400 may be heat-exchanged in the third heat-exchanger 230, so that the temperature of the coolant circulating the second coolant circuit 400 is increased. As the twenty-first coolant line 411, the second connection line 362, and the twenty-third coolant line 413 form a closed circuit, the high-temperature coolant circulating the second coolant circuit 400 is not introduced into the hydrogen compression tank 500.

The adsorption mode is described in detail with reference to FIG. 4 and FIG. 6. The adsorption mode may be a mode for adsorbing the hydrogen gas onto the metal inside the hydrogen compression tank 500 and storing the adsorbed hydrogen gas.

Referring to FIG. 4 and FIG. 6, the operation of the cooling valve 340 in the adsorption mode is the same as the cooling mode. However, in the adsorption mode, the first hydrogen valve 560 may be opened, and the second hydrogen valve 570 may be blocked.

Depending on the operation of the cooling valve 340, the eleventh coolant line 311, the first connection line 361, and the twelfth coolant line 312 may form a closed circuit, and the twenty-first coolant line 411, the second connection line 362, and the twenty-third coolant line 413 may form a closed circuit.

As the eleventh coolant line 311, the first connection line 361, and the twelfth coolant line 312 form a closed circuit, the cold refrigerant circulating the first refrigerant circuit 100 and the coolant circulating the first coolant circuit 300 may be heat-exchanged in the second heat-exchanger 140, so that the temperature of the coolant circulating the first coolant circuit 300 is lowered.

The cooled coolant may cool the hydrogen compression tank 500 through the first connection line 361 and the coolant inlet line 520, and the metal stored inside the tank body 510 may be cooled.

As the first hydrogen valve 560 is opened, the hydrogen gas may be introduced into the tank body 510 through the hydrogen inlet line 540.

The hydrogen gas introduced into the tank body 510 may be adsorbed on the cooled metal, and the hydrogen gas may be stored inside the tank body 510.

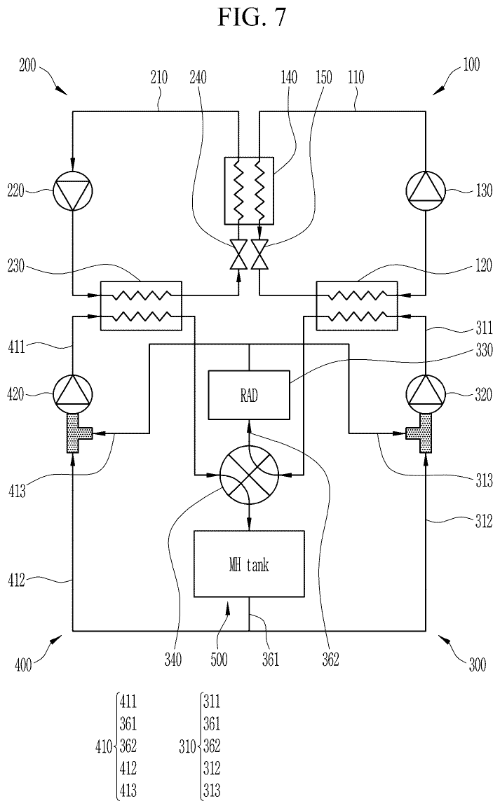

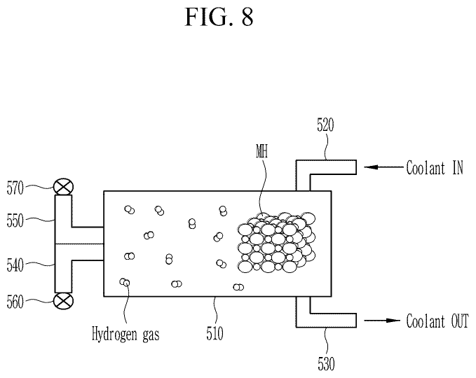

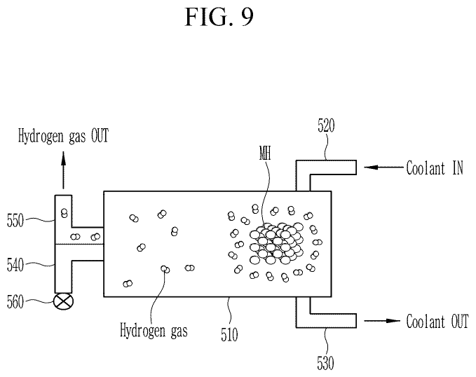

The heating mode is described in detail with reference to FIG. 7 and FIG. 8. The heating mode may be a compression mode for heating the metal hydride and compressing the hydrogen gas inside the tank body 510.

Referring to FIG. 7 and FIG. 8, in the heating mode, the cooling valve 340 may be fluidically connect the eleventh coolant line 311 and may fluidically connect the second connection line 362, and the twenty-first coolant line 411 and the first connection line 361. In addition, the first hydrogen valve 560 and the second hydrogen valve 570 may be blocked.

Depending on the operation of the cooling valve 340, the eleventh coolant line 311, the second connection line 362, and the thirteenth coolant line 313 may form a closed circuit, and the twenty-first coolant line 411, the first connection line 361, and the twenty-second coolant line 412 may form a closed circuit.

As the twenty-first coolant line 411, the first connection line 361, and the twenty-second coolant line 412 form a closed circuit, the cold refrigerant circulating the second refrigerant circuit 200 and the coolant circulating the second coolant circuit 400 may be heat-exchanged in the third heat-exchanger 230, so that the temperature of the coolant circulating the second coolant circuit 400 is increased.

The heated coolant may heat the hydrogen compression tank 500 through the first connection line 361 and the coolant inlet line 520, and the metal hydride stored inside the tank body 510 may be heated. When the metal hydride is heated, hydrogen molecules may be desorbed from the metal hydride.

Because the first hydrogen valve 560 and the second hydrogen valve 570 are blocked, the pressure of the hydrogen gas desorbed from the metal hydride inside the hydrogen compression tank 500 may gradually increase.

In addition, the cold refrigerant circulating the first refrigerant circuit 100 and the coolant circulating the first coolant circuit 300 may be heat-exchanged in the second heat-exchanger 140, so that the temperature of the coolant circulating the first coolant circuit 300 is lowered. As the eleventh coolant line 311, the second connection line 362, and the thirteenth coolant line 313 form a closed circuit, the low-temperature coolant circulating the first coolant circuit 300 is not introduced into the hydrogen compression tank 500.

The discharge mode is described in detail with reference to FIG. 7 and FIG. 9. The discharge mode may be a mode in which the hydrogen gas compressed inside the tank body 510 is discharged.

Referring to FIG. 7 and FIG. 9, in the discharge mode, the operation of the cooling valve 340 is the same as the heating mode. However, in the discharge mode, the first hydrogen valve 560 may be blocked, and the second hydrogen valve 570 may be opened.

Depending on the operation of the cooling valve 340, the eleventh coolant line 311, the second connection line 362, and the thirteenth coolant line 313 may form a closed circuit, and the twenty-first coolant line 411, the first connection line 361, and the twenty-second coolant line 412 may form a closed circuit.

As the twenty-first coolant line 411, the first connection line 361, and the twenty-second coolant line 412 form a closed circuit, the cold refrigerant circulating the second refrigerant circuit 200 and the coolant circulating the second coolant circuit 400 may be heat-exchanged in the third heat-exchanger 230, so that the temperature of the coolant circulating the second coolant circuit 400 is increased.

The heated coolant may heat the hydrogen compression tank 500 through the first connection line 361 and the coolant inlet line 520, and the metal hydride stored inside the tank body 510 may be heated. When the metal hydride is heated, hydrogen molecules may be desorbed from the metal hydride.

Because the first hydrogen valve 560 is blocked and the second hydrogen valve 570 is opened, the hydrogen gas compressed inside the hydrogen compression tank 500 may be discharged to the outside through the hydrogen discharge line 550.

In addition, the cold refrigerant circulating the first refrigerant circuit 100 and the refrigerant circulating the first coolant circuit 300 may be heat-exchanged in the second heat-exchanger 140, so that the temperature of the coolant circulating the first coolant circuit 300 is lowered. As the eleventh coolant line 311, the second connection line 362, and the thirteenth coolant line 313 form a closed circuit, the low-temperature coolant circulating the first coolant circuit 300 is not introduced into the hydrogen compression tank 500.

According to a hydrogen supply system according to an embodiment, by storing and compressing the hydrogen gas depending on the temperature change of the metal hydride, the consumption of electrical energy may be minimized, and the maintenance cost may be reduced.

Although the embodiments of the present disclosure have been described, the present disclosure is not limited thereto. It is possible to carry out various modifications within the scope of the claims, the detailed description of the disclosure, and the accompanying drawings. The modifications belong to the scope of the present disclosure.

### DESCRIPTION OF SYMBOLS

100: first refrigerant circuit
110: first refrigerant line
120: first heat-exchanger
130: first compressor
140: second heat-exchanger
150: first expansion valve
200: second refrigerant circuit
210: second refrigerant line
220: second compressor
230: third heat-exchanger
240: second expansion valve
300: first coolant circuit
310: first coolant line
311: eleventh coolant line
312: twelfth coolant line
313: thirteenth coolant line
320: first coolant pump
330: radiator
340: cooling valve
361: first connection line
362: second connection line
400: second coolant circuit
410: second coolant line
411: twenty-first coolant line
412: twenty-second coolant line
413: twenty-third coolant line
420: second coolant pump
500: hydrogen compression tank
510: tank body
520: coolant inlet line
530: coolant discharge line
540: hydrogen inlet line
550: hydrogen discharge line
560: first hydrogen valve
570: second hydrogen valve

What is claimed is:

1. A hydrogen supply system, comprising:
a first refrigerant circuit comprising:
a first refrigerant line along which refrigerant circulates; and
a first heat-exchanger, a first compressor, a second heat-exchanger, and a first expansion valve sequentially disposed on the first refrigerant line;
a second refrigerant circuit comprising:
a second refrigerant line along which the refrigerant circulates; and
the second heat-exchanger, a second compressor, a third heat-exchanger, and a second expansion valve sequentially disposed on the second refrigerant line; and
a coolant circuit comprising:
a coolant line along which coolant is selectively heat-exchanged with the refrigerant circulating the first refrigerant circuit and the refrigerant circulating the second refrigerant circuit circulates; and
a hydrogen compression tank disposed on the coolant line and configured to store a metal hydride,
wherein hydrogen gas is stored and compressed through a metal stored in the hydrogen compression tank depending on a temperature change of the coolant circulating the coolant line.

2. The hydrogen supply system of claim 1, wherein the coolant circuit comprises:
a first coolant circuit comprising:
a first coolant line along which the coolant is heat-exchanged with the refrigerant circulating the first refrigerant circuit circulates; and
a connection line selectively connected to the first coolant line and on which the hydrogen compression tank is disposed;
a second coolant circuit comprising:
a second coolant line along which the coolant is heat-exchanged with the refrigerant circulating the second refrigerant circuit circulates;
the connection line selectively connected to the second coolant line and on which the hydrogen compression tank is disposed; and
a cooling valve installed on the connection line and configured to selectively supply the coolant circulating the first coolant line and the coolant circulating the second coolant line to hydrogen compression tank.

3. The hydrogen supply system of claim 2, wherein the cooling valve is a 4-way valve.

4. The hydrogen supply system of claim 2, wherein the first coolant line comprises:
an eleventh coolant line on which a first coolant pump and the first heat-exchanger are disposed;
a first connection line selectively and fluidically connected to the eleventh coolant line and on which the hydrogen compression tank is disposed;
a second connection line selectively and fluidically connected to the eleventh coolant line and on which a radiator is disposed;
a twelfth coolant line selectively and fluidically connected to the first connection line; and
a thirteenth coolant line selectively and fluidically connected to the second connection line.

5. The hydrogen supply system of claim 4, wherein the second coolant line comprises:
a twenty-first coolant line on which a second coolant pump and the third heat-exchanger are disposed;
the first connection line selectively and fluidically connected to the twenty-first coolant line and on which the hydrogen compression tank is disposed;
the second connection line selectively and fluidically connected to the twenty-first coolant line and on which the radiator is disposed;
a twenty-second coolant line selectively and fluidically connected to the first connection line; and
a twenty-third coolant line selectively and fluidically connected to the second connection line.

6. The hydrogen supply system of claim 5, wherein the cooling valve is installed at a location where the first connection line, the second connection line, the eleventh coolant line, and the twenty-first coolant line join.

7. The hydrogen supply system of claim 6, wherein the hydrogen compression tank comprises:
a tank body configured to accommodate the metal hydride;
a coolant inlet line selectively and fluidically connected to the second connection line;
a coolant discharge line selectively and fluidically connected to the first connection line;
a hydrogen inlet line configured to supply the hydrogen gas to the tank body and on which a first hydrogen valve is disposed; and
a hydrogen discharge line configured to discharge the hydrogen gas desorbed from the metal hydride and on which a second hydrogen valve is disposed.

8. The hydrogen supply system of claim 6, wherein, depending on operations of the cooling valve, a first hydrogen valve, and a second hydrogen valve, the hydrogen supply system is configured to operate in one mode among:
a cooling mode for cooling the metal of the hydrogen compression tank;
an adsorption mode for adsorbing the hydrogen gas on the metal in the hydrogen compression tank;
a heating mode for heating the metal hydride in the hydrogen compression tank; and
a discharge mode for discharging the hydrogen gas compressed at the hydrogen compression tank.

9. The hydrogen supply system of claim 8, wherein, in the cooling mode:
the cooling valve fluidically is configured to connect the eleventh coolant line and the first connection line and is configured to fluidically connect the twenty-first coolant line and the second connection line; and
the first hydrogen valve and the second hydrogen valve are blocked.

10. The hydrogen supply system of claim 8, wherein, in the adsorption mode:
the cooling valve fluidically is configured to connect the eleventh coolant line and the first connection line and is configured to fluidically connect the twenty-first coolant line and the second connection line;
the first hydrogen valve is opened; and
the second hydrogen valve is blocked.

11. The hydrogen supply system of claim 8, wherein, in the heating mode:
the cooling valve fluidically is configured to connect the eleventh coolant line and the second connection line and is configured to fluidically connect the twenty-first coolant line and the first connection line; and
the first hydrogen valve and the second hydrogen valve are blocked.

12. The hydrogen supply system of claim 8, wherein, in the discharge mode:
the cooling valve is configured to fluidically connect the eleventh coolant line and the second connection line and is configured to fluidically connect the twenty-first coolant line and the first connection line;
the first hydrogen valve is blocked; and
the second hydrogen valve is opened.

13. The hydrogen supply system of claim 9, wherein, in the cooling mode:
the eleventh coolant line, the first connection line, and the twelfth coolant line form a first closed circuit; and
the twenty-first coolant line, the second connection line, and the twenty-third coolant line form a second closed circuit.

14. The hydrogen supply system of claim 10, wherein, in the adsorption mode:
the eleventh coolant line, the first connection line, and the twelfth coolant line form a first closed circuit; and
the twenty-first coolant line, the second connection line, and the twenty-third coolant line form a second closed circuit.

15. The hydrogen supply system of claim 11, wherein, in the heating mode:
the eleventh coolant line, the second connection line, and the thirteenth coolant line form a first closed circuit; and
the twenty-first coolant line, the first connection line, and the twenty-second coolant line form a second closed circuit.

16. The hydrogen supply system of claim 12, wherein, in the
discharge mode:
the eleventh coolant line, the second connection line, and the thirteenth coolant line form a first closed circuit; and
the twenty-first coolant line, the first connection line, and the twenty-second coolant line form a second closed circuit.
